(19) United States
(12) Patent Application Publication
(10) Pub. No.: US 2006/0149557 A1
(43) Pub. Date: Jul. 6, 2006

(54) Sentence displaying method, information processing system, and program product

(76) Inventors: Miwa Kaneko, Yokohama-shi (JP); Kazuo Aoki, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/325,583

(22) Filed: Jan. 4, 2006

(30) Foreign Application Priority Data
Jan. 4, 2005 (JP) 2005-207

(51) Int. Cl. G10L 11/00

(52) U.S. Cl. 704/277

(57) ABSTRACT

A method of displaying a sentence described in a first language using an information processor includes the steps of input-reception for receiving an input of the sentence described in the first language; separation of separating the input sentence into each constituent word; a determination of determining whether the constituent word is a predetermined specific word; and a display of display the constituent word in a second language in response to the determination that the constituent word is the predetermined specific word.

### BACKGROUND OF THE INVENTION

The present invention relates to a method of displaying a sentence described in other than a native language of a user using the sentence, as well as an information processor, a program, and an information processing system to perform the method.

Conventionally, there is a known method of supporting writing and reading sentences (hereinafter, referred to as “foreign-language sentences” as appropriate) in a non-native language of a user using a translation program by a computer. For example, in the program for checking the spelling of the words in the foreign-language sentences input by the user, it determines whether the spellings of input words are correct by checking them against a dictionary of the foreign language, and notifies the user of the misspelling if it is present.

With such spell-check programs, it has become possible to notify the user of the mistakes as to the spelling. Moreover, there is a known method of detecting the misspelling in the sentences and displaying the correct word for the misspelled word (e.g., Patent Document 1). According to this method, it is possible to detect the misspelling and display a proposed correction of words with high accuracy to correct the misspelling.

Japanese Unexamined Patent Publication (Kokai) No. 2003-223437

### SUMMARY OF THE INVENTION

Even if the spell-check is performed for the respective words in the sentences as described above, however, cautions can not be given to the user as to the incorrect usage of the words (misusage of the words). In other words, the spell-check method can not detect the incorrect usage of the word when it is mistaken for a similar word as to the form or the pronunciation while the sentence bears no incorrect spelling.

For example, when the user writes a sentence “The register on the planar should be changed.”, it will exhibit no problem because all the words in the sentence are correctly spelled. However, when the user intended to input the word “resistor (chip resistor)” instead of “register (record)”, it results in the sentence being written with the incorrect word not intended by the user. It is therefore desirable to provide a method that allows the user to find such mistakes intuitively to correct them when the words themselves are misused while they are correctly spelled.

Meanwhile, upon reading the sentences as well, the mistakable words may be mistranslated while continuing reading. It is thus desirable to provide a method that allows the user to find such reading mistakes intuitively to correct them.

It is an object of the present invention to provide a method, an apparatus and a system for displaying foreign-language sentences, providing a sentence-writing support method and a correction method, an information processor, and an information processing system that allow the user more readily to find the misusage of the words. It is another object of the present invention to provide a sentence-reading support method, an information processor, and an information processing system for supporting the user to read the foreign-language sentences, with displaying concurrent translation of the mistakable words on, for example, foreign-language emails and websites for the user.

Therefore, according to one aspect of the present invention, the present inventor provides a method of displaying a sentence described in a first language using an information processor, including the steps of receiving an input of the sentence described in the first language, separating the input sentence into constituent words, determining whether one of the constituent words is a predetermined specific word, and displaying the constituent word in a second language in response to the determination that the constituent word is the predetermined specific word.

More specifically, there is provided the method wherein the specific word is a mistakable word among the words or word groups used in the first language.

According to the present invention, when the sentence is displayed in the first language, the word or the word group among the constituent words of the sentence determined to be mistakable in the first language is displayed in the second language. Thus, without determining the mistakable word among the constituent words of the sentence described in the first language, the mistakable word is displayed in the second language.

Thus, according to the present invention, it is possible to allow the user to recognize more readily the word or the word group being misused when the user is writing the foreign-language sentences, by separating the sentences into words, determining the word or the word group that the user tends to misuse among the separated words or word groups, and displaying the determined word in the user's native language. Additionally, there is provided the sentence-reading support method of supporting the user to read the foreign-language sentences, by separating the sentences into words, determining the word or the word group that the user tends to misuse among the separated words or word groups, and displaying the determined word in the user's native language.

According to the present invention, when the sentence is displayed in the first language, the word or the word group determined to be the specific word among the constituent words of the sentence is displayed in the second language. Thus, without determining the specific word among the constituent words of the sentence described in the first language, the specific word is displayed in the second language. As a result, the user browsing documents in the first language can view specific words displayed in the second language without performing a specific operation.

### BRIEF DESCRIPTION OF THE DRAWINGS

FIG. 1 is a diagram illustrating a hardware configuration of an information processor 1;

FIG. 2 is a schematic diagram of a second dictionary memory section 25 according to an embodiment of the present invention;

FIG. 3 is a diagram illustrating a record format of a mistakable word dictionary according to the embodiment of the present invention;

FIG. 4 is a flowchart illustrating operations executed by the information processor 1 according to the embodiment of the present invention;

FIG. 5 is a flowchart illustrating operations executed in a morphological analysis;

FIG. 6 is a graph illustrating ratios of a word determined to be mistakable when words contain identical spellings;

FIG. 7 is a flowchart illustrating operations to determine whether the word is mistakable;

FIG. 8 is a screen image that appears on a display unit showing sentences in a first language and translations of the words determined to be mistakable; and

FIG. 9 is a diagram illustrating a hardware configuration of an information processing system 100.

### DESCRIPTION OF THE PREFERRED EMBODIMENTS

Hereinafter, preferred embodiments of the present invention will be described based on the drawings.

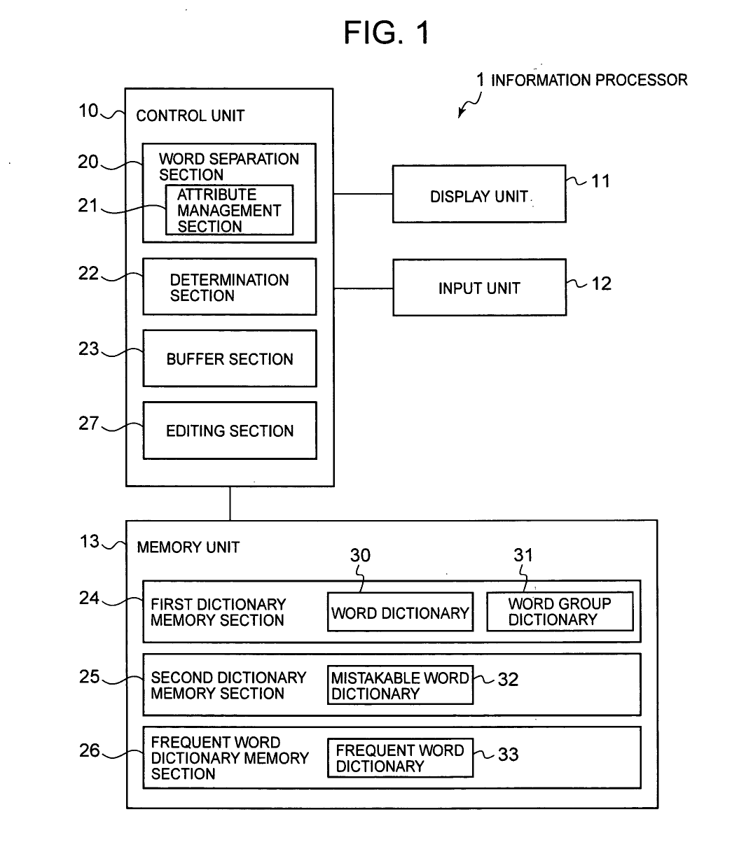

FIG. 1 shows a hardware configuration of an information processor 1. The information processor 1 is provided with an input unit 12 to receive an input of a sentence in a first language by a user, a display unit 11 to display the sentence in the input first language or a translation thereof in a second language, a control unit 10 to perform recognition of a word in the input sentence in the first language or a dictionary search, and a memory unit 13 to store a word dictionary or other dictionaries. The information processor 1 may be an ordinary computer, a compact personal terminal (e.g., a PDA) or a mobile phone.

Here, the first language denotes the language other than the user's native language, which may be a foreign language. The second language denotes the user's native language or second native language. Moreover, a specific word denotes a word or a word group of the first language requiring being displayed in the second language as well, which may be, for example, a commonly mistakable word (or word group) in writing or reading the sentences in the first language.

The input unit 12 receives the input of the sentence in the first language by the user and sends input information to the control unit 10 or the memory unit 13. The input unit 12 may be, for example a keyboard, a mouse, a voice input system (e.g., a microphone), or the like. The display unit 11 displays the input foreign-language sentence or an operation result by the control unit 10. It may be, for example, a computer monitor which includes a liquid crystal display monitor.

The control unit 10 controls the information in the information processor 1. The control unit 10 may be a conventional central processing unit (CPU), or may be provided with a buffer section 23, which temporarily stores data, information or flags, and an editing section 27. The buffer section 23 is, for example, a cache or a RAM in the CPU. The buffer section 23 may be provided in the memory unit 13 instead of the control unit 10. The buffer section 23 may store the word or the word group itself to be determined, or the information related to attributes of the word or the word group (such as word class information of the target word or word group, stop word information, or unknown word information: hereinafter, referred to as the “attribute information”). Here, the unknown word information denotes the information related to generally unfamiliar words (unknown words). In other words, the unknown word information denotes the information of the words which are not listed in ordinary dictionaries or the like. Moreover, the stop word information denotes the information related to the attributes of the words not to be processed (e.g., the word or the word group not to be displayed in the second language). The buffer section 23 may also store the word or the word group determined to be mistakable in the second language (translation).

The control unit 10 may include a word separation section 20 to separate the words in the sentence input by the user in the first language, a determination section 22 to determine whether each of the words or the word groups are a specific word or word groups, and the editing section 27 to accept editing by the user of the word determined to be the specific word in the sentence displayed in the first language. Moreover, the word separation section 20 may include an attribute management section 21 and the buffer section 23. The attribute management section 21 may store the attribute information of the separated words in the buffer section 23 together with the word in the first language and the word in the second language (translation).

The word separation section 20 separates the words and the word groups in the sentence in the first language into constituent words using a word boundary, e.g., a space, a comma, or a colon, as a marker. The constituent word herein may be either the single word or the word group consisting of a plurality of words. Moreover, the word separation section 20 may separate the words in the foreign-language sentence to apply attributes based on the words listed in a word dictionary 30.

The determination section 22 determines whether the input constituent word is a specific word (mistakable word) or not. In the determination, the determination section 22 refers to a mistakable word dictionary 32 stored in the memory unit 13 and determines the word or the word group to be mistakable when it is stored in the mistakable word dictionary 32.

The memory unit 13 stores data, dictionaries, foreign-language sentences, or translations, used in the information processor 1. The memory unit 13 may be, for example a hard disk, a CD-ROM, a DVD-ROM or the like. The memory unit 13 stores the dictionaries which contain a large amount of data related to words, and it may be provided with a first dictionary memory section 24, a second dictionary memory section 25, and a frequent word dictionary memory section 26. The first dictionary memory section 24 stores the word dictionary 30 and a word group dictionary 31. The word dictionary 30 is the data containing the words in the first language and the words in the second language corresponding thereto (translation), as well as the word classes of the words. The word group dictionary 31 stores data containing the word groups, i.e., idioms or compound words (e.g., “trick-or-treat”), and the translations corresponding thereto, as well as the word classes of the word groups.

The second dictionary memory section 25 includes a mistakable word dictionary 32. The mistakable word dictionary 32 is configured so as to use a record format in which the mistakable word and the translation thereof in the second language are registered as a set of words (see FIG. 3). The record format of the mistakable word dictionary may be composed of an entry word (the constituent word shown in the first language) with the translation thereof (the word shown in the second language corresponding to the constituent word in the first language), a classification code, and a similar word (the word determined to be similar to the constituent word in the first language based on, for example later-described rules) with the translation thereof (the word shown in the second language corresponding to the similar word). Here, the classification code denotes the information associated with the constituent word, e.g., which of the later-described rules the word corresponds to.

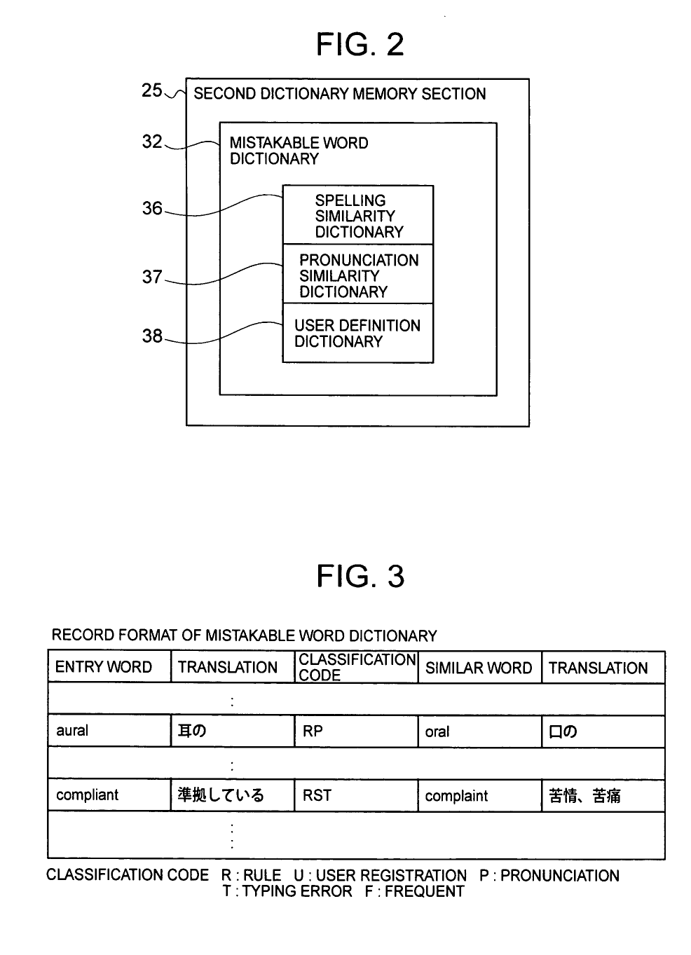

The mistakable word dictionary 32 may include a spelling similarity dictionary 36 that classifies words as mistakable based on whether there is any other word or word group similar in spelling, may include a pronunciation similarity dictionary 37 that classifies words as mistakable based on whether there is any other word or word group similar in pronunciation, or may include a user definition dictionary 38 containing the mistakable words registered by the user. The user definition dictionary 38 may contain the mistakable words and the translations thereof in the form of a set of words, or separately (i.e., the entry word, the translation thereof, and the classification code only; not as a set of words) (see FIG. 2).

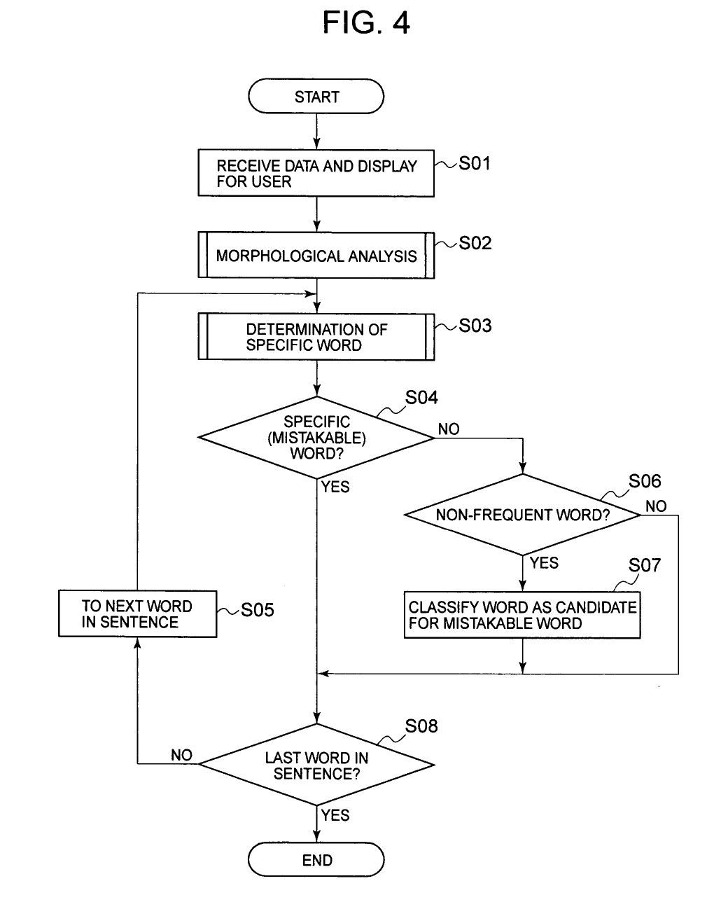

FIG. 4 is a flowchart illustrating information processing executed by the information processor 1 according to the embodiment of the present invention. First, the input of the sentence by the user in the first language is received by the input unit 12 (Step S01). The input may be received via a dedicated application executing the information processing of the present invention, or via a general-purpose application software for generating documents, so that the application software executing the information processing of the present invention operates subordinately against the input foreign-language sentence.

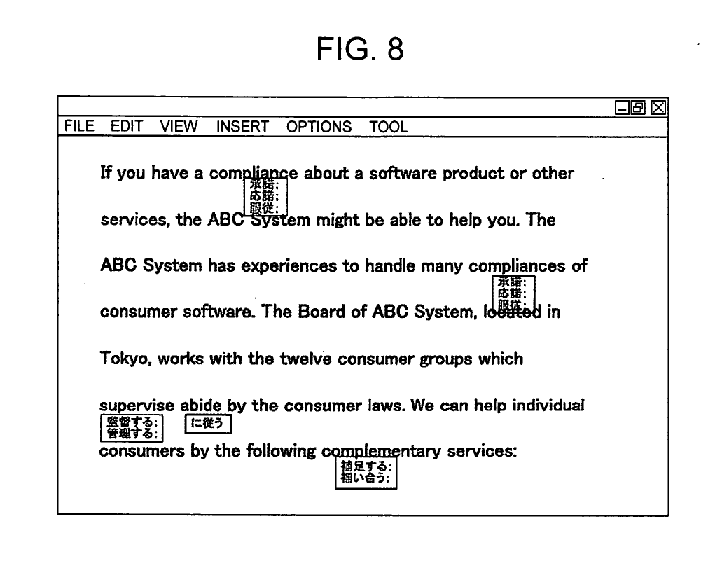

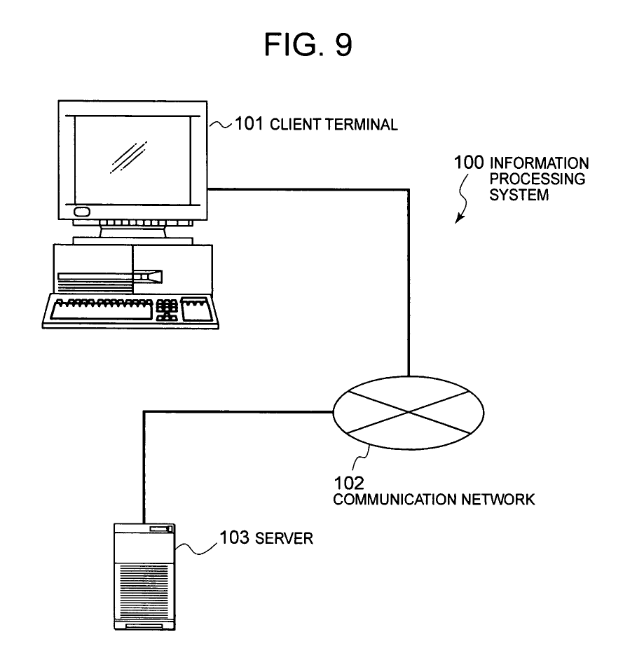

The sentence input may be performed, for example, by receiving the input of the foreign-language sentence from the server and displaying the input. The operation will be described below referring to FIG. 8.

Moreover, Step S02 may start by receiving the input of translation confirmation by the user (e.g., clicking on an icon) after the input of a series of sentences in the first language.

The control unit 10 executes a morphological analysis of the input sentence in the first language (Step S02). The morphological analysis denotes separating the input sentence in the first language into words and applying the word class, the attribute, a stop word attribute, an unknown word attribute or the like to the respective words. A frequent word may be registered as a stop word.

The determination section 22 determines whether the word is the specific word (mistakable word) by searching the mistakable word dictionary, based on the morphological analysis information related to the word and the respective dictionaries stored in the memory unit 13 (Steps S03 and S04). The determination as to whether the word is mistakable will be described later in a section describing a mistakable word determination routine (FIG. 7). Next, the determination section 22 determines whether the word is the frequent word (Step S06). The frequent word denotes the word frequently used for usual writing of the sentences in the first language. That is, the user is not likely to misuse the word if it is the frequent word, so that the word is determined not to be the mistakable word. While the word extracted as a frequently-used word may be registered in the frequent word dictionary 33, the proper nouns, the words described in Katakana, or the basic words that are taught at, for example, a foreign-language school may also be registered in the frequent word dictionary 33. Alternately, the frequent word may be extracted with a stop word attribute being applied.

After the word is determined to be the frequent word in Step S06, it is determined whether a subsequent word is a mistakable word (Step S05) when the subsequent word (words) still remains in the sentence in the first language (Step S08). When the word is determined not to be the frequent word, the process proceeds to Step S07. If the word is determined to be the mistakable word, it is stored in for example the buffer section 23 with the word in the second language (translation) as a candidate for the mistakable word (Step S07). The mistakable word in the second language may be displayed as the candidate for the mistakable word.

For example, the user may select whether to display any one in the second language of or any combination of: 1) a non-frequent word stored in the mistakable word dictionary 32; 2) the frequent word stored in the mistakable word dictionary; and 3) the frequent word not stored in the mistakable word dictionary. Additionally, the user may change a threshold value (extraction ratio) of the above-described similar word determined to be similar to the constituent word in the first language based on the rules described below or of the non-frequent word.

Moreover, since the mistakable word dictionary stores the mistakable word together with the similar word in the record format, the editing step may be provided to display the candidate words for correction as a “proposed correction of words” associated with the mistakable word. In other words, the user may select the word among the proposed correction of words or input correction via the editing section 27 by displaying the proposed correction of words.

Furthermore, upon reception of the input by the user after Step S08, the mistakable word displayed together with the translation thereof may be substituted by a different word. That is, when the user recognizes that the mistakable word is misspelled, the user inputs the correct word. The mistakable word may be corrected (substituted) upon reception of the input by the user.

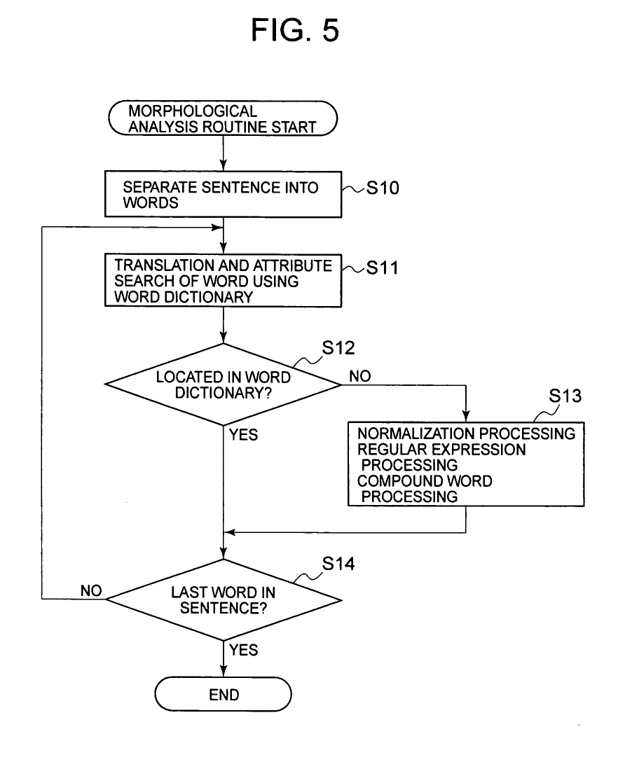

Referring now to FIG. 5, the morphological analysis operation will now be explained. The word separation section 20 separates the sentence in the first language into words (Step S10). The attribute (e.g., the word class, the stop word, or the unknown word) is applied to the separated word (Step S11). It is determined whether the word is found in the word dictionary 30 of the first dictionary memory section 24 (Step S12). If the word is not found, regular expression processing, normalization processing, or compound word processing may be operated (Step S13). The normalization processing may be the processing to search for the word again in the word dictionary after excluding unnecessary letters, a number, or a symbol if the word contains any of them. The compound word processing may be the processing to search a hyphenated word consisting of a plurality of words or an idiom as a single word in the word dictionary instead of searching for the individual words only. The regular expression processing denotes the processing to make, for example, a URL (Uniform Resource Locator) recognized as a single word. The process is repeated from Step S11 until the end of the process for all the words in the sentence in the first language (Step S14).

The following describes the determination of the mistakable word by the information processor 1. The mistakable word dictionary 32 may store the “similar word” as to the spelling or the pronunciation together with the translation thereof. That is, the word is determined to be mistakable based on whether the similar word is present. The dictionary may be customized by the user to register the word which the user recognizes to be mistakable or to delete the word. The record format for the mistakable word dictionary may be hierarchically composed of the entry word: the translation; the classification (; the similar word: the translation), as described above referring to FIG. 3.

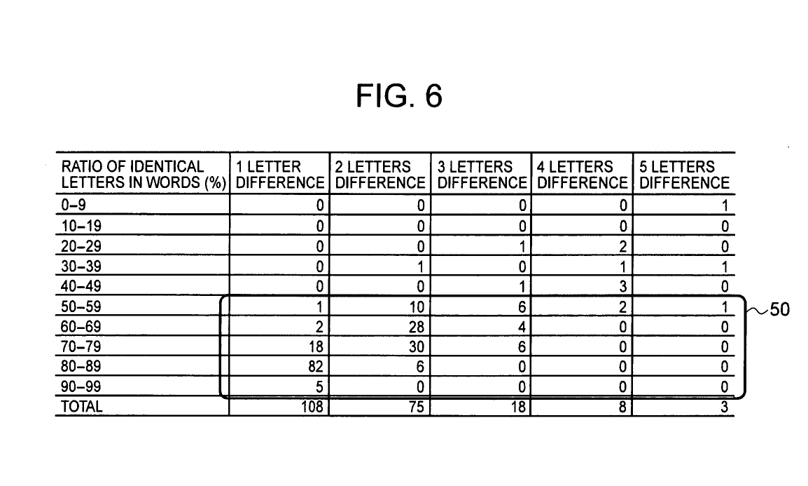

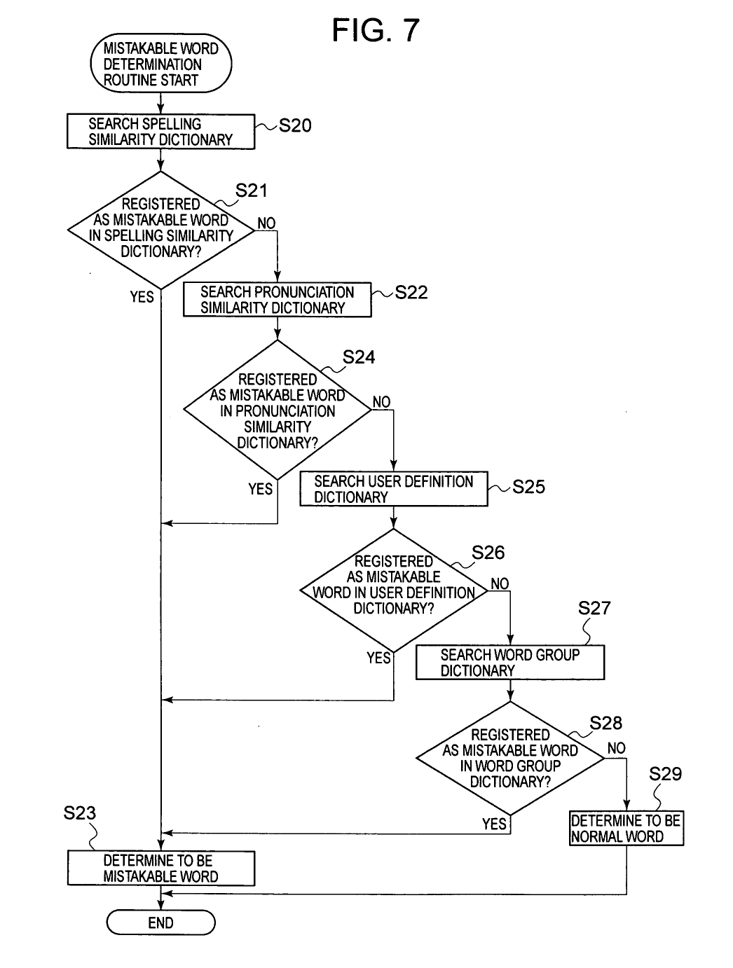

There are documents listing the words that are commonly recognized to be mistakable. For example, “Common Errors in English” by Paul Brians lists the mistakable words. Among 212 sets of words in this document, the word pairs in which 50% or more of the spellings are identical to each other account for 94.8% (201 pairs) (see Graph 50 in FIG. 6). The remaining 11 pairs are, for example, accede/exceed, bare/bear, cite/sight, close/clothes, council/consul, and counsel/consul; all of which exhibit the pronunciation similarity. Thus, the words recognized to be mistakable can be classified based on the similarity in the spelling and the pronunciation.

The similarity in the spelling is determined by applying the rules described hereinbelow. Here, it is provided that either or both of the first and last letters of the respective words are identical. The number of letters herein denotes the number of the letters constituting the word (e.g., both “adapt” and “adopt” consist of 5 letters each). Here, the “word pair” denotes “the word and another word compared thereto” (e.g., “adapt” and “adopt”). The concordance ratio is the value obtained by dividing the number of identical letters by the number of letters of the longer word.

Rule 1: In the case of the words the same or different in the number of letters, the number of different letters in the identical positions is:

For the word pair of 2 to 3 letters:
only 1 letter is different

For the word pair of 4 to 5 letters:
2 letters or less are different

For the word pair of 6 to 7 letters:
3 letters or less are different

For the word pair of 8 to 9 letters:
4 letters or less are different

For the word pair of more than or equal to 10 letters:
5 letters or less are different

Example: adapt/adopt (4 letters are identical) (For the word pair of same word length: count the identical letters in the identical positions. For the word pair of different word length: count the identical letters from the beginning of the word if the first letter is identical, or count the identical letters from the end of the word if the first letter is not identical and the last letter is identical.)

Rule 2: In the case of the words the same or different in the number of letters, the concordance ratio of letters in the identical positions of the word pair is 50% or more (For the word pair of same word length: count the identical letters in the identical positions. For the word pair of different word length: count the identical letters from beginning of the word if the first letter is identical, or count the identical letters from the end of the word if the first letter is not identical and the last letter is identical).

Example:
continual/continuous
   (7 letters are identical; 7/10=70% of concordance ratio)
compliance/complaint
   (6 letters are identical; 6/10=60% of concordance ratio)
aural/oral
   (3 letters are identical; 3/5=60% of concordance ratio)

Rule 3: In the case of the words the same or different in the number of letters, the number of different letters in the different or identical positions is:

For the word pair of 2 to 3 letters:
only 1 letter is different

For the word pair of 4 to 5 letters:
2 letters or less are different

For the word pair of 6 to 7 letters:
3 letters or less are different

For the word pair of 8 to 9 letters:
4 letters or less are different

For the word pair of more than or equal to 10 letters:
5 letters or less are different
   (For the word pair of same word length: count the identical letters in the identical positions. For the word pair of different word length: count the identical letters from the beginning of the word the first letter is identical, or count the identical letters from the end of the word if the first letter is not identical and the last letter is identical.)

Rule 4: In the case of the words the same or different in the number of letters, the concordance ratio of letters in the different or identical positions of the word pair is 50% or more (For the word pair of same word length: count the identical letters in the identical positions. For the word pair of different word length: count the identical letters from the beginning of the word if the first letter is identical, or count the identical letters from the end of the word if the first letter is not identical and the last letter is identical).

Example:
bear/bare
   (4 letters are identical; 4/4=100% of concordance ratio)
close/clothes
   (5 letters are identical; 5/7=71% of concordance ratio)
fiscal/physical
   (5 letters are identical; 5/8=63% of concordance ratio)

Rule 5: In the case of the words the same or different in the number of letters, the concordance ratio of letters in the identical positions of the word pair is 80% or more, and the numbers of letters are equal to or less than 5 while 2 letters from the beginning of each word are identical (For the word pair of same word length: count the identical letters in the identical positions. For the word pair of different word length: count the identical letters from the beginning of the word if the first letter is identical, or count the identical letters from the end of the word if the first letter is not identical and the last letter is identical).

Next, the similarity in the pronunciation is determined by applying the rules described hereinbelow. Here, it is provided that either or both of the first and last syllables of the respective words are identical. The number of syllables herein denotes the number of the syllables constituting the word (e.g., both cite/sight (sa'it/sa'it) consist of 4 syllables respectively). Here, the “word pair” denotes “the word and another word compared thereto” (e.g., “cite” and “sight”). The concordance ratio is the value obtained by dividing the number of identical syllables by the number of syllables of the word consisting of the greater number of syllables.

Rule 6: In the case of the words the same or different in the number of syllables, the number of different syllables in the identical positions is:

For the word pair of 2 to 3 syllables:
only 1 syllable is different

For the word pair of 4 to 5 syllables:
2 syllables or less are different

For the word pair of 6 to 7 syllables:
3 syllables or less are different

For the word pair of 8 to 9 syllables:
4 syllables or less are different

For the word pair of more than or equal to 10 syllables:
5 syllables or lessare different

Example: cite/sight (4 syllables are identical) (For the word pair of same word length: count the identical syllables in the identical positions. For the word pair of different word length: count the identical syllables from the beginning of the word if the first syllable is identical, or count the identical syllables from the end of the word if the first letter is not identical and the last syllable is identical.)

Rule 7: In the case of the words the same or different in the number of syllables, the concordance ratio of syllables in the identical positions of the word pair is 50% or more (For the word pair of same word length: count the identical syllables in the identical positions. For the word pair of different word length: count the identical syllables from the beginning of the word if the first syllable is identical, or count the identical syllables from the end of the word if the first letter is not identical and the last syllable is identical).

Example:
cite/sight sa'it/sa'it (100% of concordance ratio)

Rule 8: In the case of the words the same or different in the number of syllables, the number of different syllables in the different or identical positions is:

For the word pair of 2 to 3 syllables:
only 1 syllable is different

For the word pair of 4 to 5 syllables:
2 syllables or less are different

For the word pair of 6 to 7 syllables:
3 syllables or less are different

For the word pair of 8 to 9 syllables:
4 syllables or less are different

For the word pair of more than 10 or equal to syllables:
5 syllables or less are different
   (For the word pair of same word length: count the identical syllables in the identical positions. For the word pair of different word length: count the identical syllables from the beginning of the word if the first syllable is identical, or count the identical syllables from the end of the word if the first letter is not identical and the last syllable is identical.)

Rule 9: In the case of the words the same or different in the number of syllables, the concordance ratio of syllables in the different or identical positions of the word pair is 50% or more (For the word pair of same word length: count the identical syllables in the identical positions. For the word pair of different word length: count the identical syllables from the beginning of the word if the first syllable is identical or count the identical syllables from the end of the word if the first letter is not identical and the last syllable is identical).

Rule 10: In the case of the words the same or different in the number of syllables, the concordance ratio of syllables in the identical positions of the word pair is 80% or more, and the numbers of syllables are equal to or less than 5 while 2 syllables from the beginning of each word are identical (For the word pair of same word length: count the identical syllables in the identical positions. For the word pair of different word length: count the identical syllables from the beginning of the word if the first syllable is identical, or count the identical syllables from the end of the word if the first letter is not identical and the last syllable is identical).

As the further rule, the word groups which are not frequently used (e.g., idioms) may be determined to be the mistakable words. These rules 1 to 10 may be applied within a specific word class to determine whether the word is mistakable after the word class is specified by, for example, the morphological analysis.

FIG. 7 is a flowchart illustrating operations to determine whether the word is mistakable. The target word is searched for in the spelling similarity dictionary 36, the pronunciation similarity dictionary 37, and the user definition dictionary 38 (Steps S20, S22, and S25). The spelling similarity dictionary 36 and the pronunciation similarity dictionary 37 store the information on whether the word is mistakable on the basis of the foregoing rules 1 to 10. Based on the registered information, it is determined whether the target word is the mistakable word. In other words, the target word is registered in the spelling similarity dictionary 36 as the mistakable word if the word satisfies any of the rules 1 to 5 (Step S21), resulting in the word being determined to be mistakable.

If the word is not registered in the spelling similarity dictionary 36 as the mistakable word, then the pronunciation similarity dictionary 37 is searched to see if the word is registered therein (Step S22). The target word is registered in the pronunciation similarity dictionary 37 as the mistakable word if the word satisfies any of the rules 6 to 10, resulting in the word being determined to be mistakable (Steps S24 and S23).

If the word is not registered in the pronunciation similarity dictionary 37 as the mistakable word, then the word group dictionary 31 is searched to see if the word is registered therein (Step S27). The target word group is registered in the word group dictionary 31 as the mistakable word if the word group is, for example, a non-frequent word group, resulting in the word group being determined to be mistakable (Step S23). The word group may be an idiom such as “call for” or a compound word such as “trick-or-treat”. The compound word may be processed as a single word, instead of being recognized as the word group.

If the target word group is not registered in the word group dictionary 31 as a mistakable word, the word group is determined to be a normal word (Step S29) and the process ends.

Instead of the process of searching the word group dictionary 31 on the word-by-word basis, as shown in FIG. 7, the word group may be processed after all the words in the sentence in the first language are searched for in, for example the spelling similarity dictionary 36 and the pronunciation similarity dictionary 37.

FIG. 8 is an example of a display image showing the input sentences in the first language and the translations of the words in the sentences in the first language determined to be mistakable. Such a screen image is displayed in the display unit 11 of the information processor 1. As shown in FIG. 8, the translation of the word determined to be mistakable may be displayed associated with the sentence (in the first language) input by the user.

In the present invention, while the translations of the words, such as “compliance” and “supervise”, in the sentences in the first language shown in FIG. 8 are displayed, the translations of the words, such as “If”, “have” and “System”, which the user is not likely to misuse are not displayed. Thus, the user can prevent misusing the words by checking only the translations of the mistakable words.

As an alternative embodiment of the present invention, an information processing system 100 may comprise a client terminal 101, a server 103, and a communication network 102 connecting the client terminal 101 and the server 103 to achieve the object of the present invention.

More specifically, the client terminal 101 may be a computer which receives the input of the sentence in the first language by the user and displaying the input result, provided with the display unit 11 and the input unit 12 of the information processor 1 described above. That is, the input sentence in the first language by the user is inputted from a client input unit of the client terminal 101 into the server 103 via the communication network 102. The server 103 is provided with the control unit 10 and the memory unit 13 of the information processor 1 described above to perform the morphological analysis or the determination of the mistakable words for the respective words in the input sentence in the first language, so that the translation of the mistakable word may be sent to the client terminal 101 and displayed in the display unit of the client terminal 101.

Moreover, the server 103 may be provided with the memory unit 13, as well as a server transmission section to send the translation of the mistakable word to the client terminal 101. In other words, the server transmission section may send the data of the word determined to be mistakable by the determination section 22 and the translation associated with each other to the client terminal 101. Furthermore, the first dictionary memory section 24, the second dictionary memory section 25, and the frequent word dictionary memory section 26 are stored in a plurality of servers, respectively. The communication network 102 may be the Internet, while a plurality of client terminals 101 may be provided.

The information processor, a sentence displaying method, and a sentence processing system practicing the foregoing embodiments can be realized by a program executed by the computer or the server. A memory medium for the program includes an optical memory medium, a tape medium, and a semiconductor memory. The memory device such as the hard disk or a RAM provided in a server system connected to a dedicated communication network or the Internet may be used as the memory medium to provide the program via the network.

While the embodiments of the present invention have been described, it is intended to only illustrate the particular examples without specifically limiting the scope of the present invention. The advantages of the present invention are not limited to the advantages described in the embodiments of the present invention, which are shown only as the most suitable advantages derived from the present invention.

The first language in the present invention to write the sentence (foreign-language sentence) is not limited to a specific language. The present invention may be realized without depending on the specific language as long as the user is writing the sentence in a language other than the native language. Moreover, the specific word in the present invention is not limited to the mistakable word in using the first language, while the specific word may include the word requiring to be displayed in the second language as well when using the first language.

1. A computer implementable method of displaying a sentence, the method comprising:
receiving the sentence in a first language;
separating the sentence into a plurality of constituent words;
comparing each of the constituent words in the sentence to a list comprising a plurality of predetermined specific words; and
displaying, in a second language, each constituent word having a corresponding predetermined specific word in the list.

2. The method according to claim 1, wherein the list comprises a plurality of mistakable words.

3. The method according to claim 1, further comprising displaying a proposed correction of words corresponding to one of the displayed constituent words.

4. The method according to claim 1, further comprising editing a constituent word displayed in the second language.

5. The method according to claim 4, further comprising receiving an input from a user to edit a constituent word.

6. The method according to claim 1, wherein the step of separating the sentence into a pluraltiy of constituent words comprises a morphological analysis to apply a word class attribute indicating a word class of the word, an unknown word attribute indicating that the word is an unknown word, or a stop word attribute indicating that the word is excluded from the words to be processed as the specific word.

7. The method according to claim 2, wherein the step of comparing includes determining whether the word is mistakable for the words or the word groups listed in a mistakable word dictionary that classifies words on the basis of mistakability.

8. A computer-usable medium embodying computer program code, the computer program code comprising computer executable instructions configured to:
receive a sentence in a first language;
separate the sentence into a plurality of constituent words;
compare each of the constituent words in the sentence to a list comprising a plurality of predetermined specific words; and
display, in a second language, each constituent word having a corresponding predetermined specific word in the list.

9. The computer-usable medium of claim 8, wherein the list comprises a plurality of mistakable words.

10. The computer-usable medium of claim 8, wherein the embodied computer program code further comprises computer executable instructions configured to display a proposed correction of words corresponding to one of the displayed constituent words.

11. The computer-usable medium of claim 8, wherein the embodied computer program code further comprises computer executable instructions configured to edit a constituent word displayed in the second language.

12. The computer-usable medium of claim 11, wherein the embodied computer program code further comprises computer executable instructions configured to receive an input from a user to edit a constituent word.

13. The computer-usable medium of claim 8, wherein the computer executable instructions configured to separate the sentence into a pluraltiy of constituent words comprises a morphological analysis to apply a word class attribute indicating a word class of the word, an unknown word attribute indicating that the word is an unknown word, or a stop word attribute indicating that the word is excluded from the words to be processed as the specific word.

14. The computer-usable medium of claim 9, wherein the computer executable instructions configured to compare includes determining whether the word is mistakable for the words or the word groups listed in a mistakable word dictionary that classifies words on the basis of mistakability thereof.

15. An information processor for displaying a sentence described in a first language comprising:
an input unit for receiving an input of the sentence described in the first language;
a word separation unit for separating the input sentence into constituent words;
a determination unit for determining whether each of the constituent words is a predetermined specific word; and
a display unit for displaying the constituent word in a second language in response to the determination that the constituent word is the predetermined specific word.

16. The information processor according to claim 15, wherein the specific word is a mistakable word among words or word groups used in the first language.

17. The information processor according to claim 15, wherein the display unit displays a proposed correction of words corresponding to the constituent word.

18. The information processor according to claim 15, further comprising an editing unit for displaying a word in the first language or the second language, the word being associated with the constituent word displayed in the second language.

19. The information processor according to claim 18, wherein the editing unit receives an input from a user to edit the constituent word.
